(19) United States
(12) Patent Application Publication
(10) Pub. No.: US 2026/0177862 A1
(43) Pub. Date: Jun. 25, 2026

(54) BACKLIGHT BRIGHTNESS ADJUSTMENT CIRCUIT AND CONTROL METHOD THEREFOR AND DEVICE

(71) Applicant: Beijing Zitiao Network Technology Co., Ltd., Beijing (CN)

(72) Inventors: Yu XIA, Beijing (CN); Guanghui LIU, Beijing (CN)

(21) Appl. No.: 18/855,207

(22) PCT Filed: Mar. 23, 2023
(86) PCT No.: PCT/CN2023/083249

§ 371 Date: Oct. 8, 2024

(30) Foreign Application Priority Data
Apr. 8, 2022 (CN) 202210369797.7

(51) Int. Cl. G02F 1/1335

(52) U.S. Cl. CPC G02F 1/133612

(57) ABSTRACT

A backlight brightness adjustment circuit and a control method therefor, and a device are provided. The circuit comprises: a control end of a first switch component is connected to an output of an AND gate circuit, one end of the first switch component is connected to one end of a first resistor, and the other end of the first switch component is connected to ground; the other end of the first resistor is connected to a first input of a voltage comparator, one end of a second switch component, and one end of a second resistor, and the other end of the second resistor is connected to the ground. Stepless adjustment of the backlight brightness is achieved and the backlight brightness adjustment experience is improved.

### CROSS REFERENCE TO RELATED APPLICATIONS

The present application claims priority to the Chinese patent application filed Apr. 8, 2022, with the application No. 202210369797.7 and the invention title “BACKLIGHT BRIGHTNESS ADJUSTMENT CIRCUIT AND CONTROL METHOD THEREFOR AND DEVICE”, the entire content of which is incorporated herein by reference in its entity.

### FIELD

Embodiments of the present application relate to the technical field of brightness adjustment, and in particular, to a backlight brightness adjustment circuit and a control method and a device thereof.

### BACKGROUND

Liquid Crystal Display (LCD for short) is a display with Light Emitting Diode (LED for short) as the backlight source. During the application process, when a non-black frame insertion LCD screen displays a picture, due to changes in each frame, each sub-pixel on the screen will control the deflection of the liquid crystal according to different voltage signals. However, the deflection of the liquid crystal takes a certain amount of time. When the data is refreshing too fast, the liquid crystal does not have enough time to react, that is, before the liquid crystal has completed deflection, the backlight source is turned on, which will cause the LCD screens to produce smear visible to the human eyes.

In order to reduce smear produced on the LCD screens, black frame insertion is used on the LCD screen to turn off the backlight during data transmission and liquid crystal deflection in each frame, and light up the backlight when the data transmission and liquid crystal deflection are completed. When using an LCD screen with black frame insertion function to display data, the user may need to adjust the backlight brightness according to the brightness of the environment. Currently, adjusting the backlight brightness includes manual adjustment and automatic adjustment. However, whether it is the automatic adjustment or the manual adjustment, the backlight brightness is divided into multiple levels, and according to each divided backlight brightness level, the value of the system brightness adjustment control that adjusts the backlight brightness is divided into multiple intervals to order to establish a mapping relationship between the backlight brightness levels and the numerical intervals. When the user manually adjusts the backlight brightness, the backlight brightness of the LCD screen is adjusted to the backlight brightness level corresponding to the numerical interval by sliding a slider on the system brightness adjustment control to a numerical interval.

However, in the above-mentioned backlight brightness adjustment method, the mapping relationship between the backlight brightness levels and the numerical intervals is the same for different users' devices, but each user has different adjustment requirements for the backlight brightness, which leads to users' dissatisfactory with the adjusted backlight brightness, resulting in poor user experience.

### SUMMARY

This application provides a backlight brightness adjustment circuit and a control method and an equipment thereof to achieve stepless adjustment of backlight brightness, thereby improving user satisfaction with backlight brightness adjustment and improving user experience.

In a first aspect, the application provides a backlight brightness adjustment circuit, comprising: an AND gate circuit, a first switch component, a second switch component, a first resistor, a second resistor, a voltage comparator, an LED array and a pull-up resistor;
a control end of the first switch component being connected to an output of the AND gate circuit, one end of the first switch component being connected to one end of the first resistor, and the other end of the first switch component being connected to ground;
the other end of the first resistor being connected to a first input of the voltage comparator, one end of the second switch component and one end of the second resistor, and the other end of the second resistor being connected to ground;
a second input of the voltage comparator being connected to the power supply, and an output of the voltage comparator being connected to a control end of the second switch component;
the other end of the second switch component being connected to the LED array and one end of the pull-up resistor, and the other end of the pull-up resistor being connected to the power supply;
a first input of the AND gate circuit being connected to a controller, and a second input of the AND gate circuit being connected to the liquid crystal display screen for controlling a working state of the first switch component according to a first pulse width modulation signal output by the controller and a second pulse width modulation signal output by the liquid crystal display screen; and
wherein, the first pulse width modulation signal is generated based on a current brightness value of a backlight of the liquid crystal display screen, and a frequency of the first pulse width modulation signal is greater than a frequency of the second pulse width modulation signal.

In the second aspect, embodiments of the present application provide a method for controlling a backlight brightness adjustment circuit, comprising:
obtaining, according to a received backlight brightness adjustment instruction, a current brightness value of a system brightness adjustment control;
determining, according to the current brightness value, a duty cycle of the pulse width modulation signal that drives the backlight of the liquid crystal display screen, the pulse width modulation signal being the first pulse width modulation signal;
controlling, according to the first pulse width modulation signal and a second pulse width modulation signal output by the liquid crystal display screen, the working state of the switch component connected to the backlight of the liquid crystal display screen to adjust the backlight brightness of the liquid crystal display screen;
wherein, a frequency of the first pulse width modulation signal is greater than a frequency of the second pulse width modulation signal.

In a third aspect, an embodiment of the present application provides an electronic device, including the backlight brightness adjustment circuit of any of the embodiments of the first aspect.

The technical solutions disclosed in the embodiments of this application have the following beneficial effects:
by setting a AND gate circuit, a first switch component, a second switch component, a first resistor, a second resistor, a voltage comparator and a pull-up resistor in a backlight brightness adjustment circuit of the screen, and according to the pulse width modulation signals output by the controller and the liquid crystal display screen, controlling whether the first resistor is connected to the backlight brightness adjustment circuit to adjust a size of a current of the backlight of the screen by adjusting a size of the current-limiting resistor in the backlight brightness adjustment circuit, thereby achieving stepless adjustment of the backlight brightness, improving user satisfaction with adjustment of backlight brightness and improving user experience.

### BRIEF DESCRIPTION OF THE FIGURES

In order to more clearly illustrate the technical solutions in the embodiments of the present application, the figures needed to be used in the description of the embodiments will be briefly introduced below. Obviously, the figures in the following description are only some embodiments of the present application. For those of ordinary skill in the art, other figures can also be obtained based on these figures without exerting creative efforts.

FIG. 1 is a schematic block diagram of a backlight brightness adjustment circuit according to embodiments of the present application;

FIG. 2 is a schematic block diagram of another backlight brightness adjustment circuit according to embodiments of the present application;

FIG. 3 is a schematic block diagram of yet another backlight brightness adjustment circuit according to embodiments of the present application;

FIG. 4 is a schematic block diagram of yet another backlight brightness adjustment circuit according to embodiments of the present application;

FIG. 5 is a schematic flowchart of a backlight brightness adjustment circuit control method according to embodiments of the present application;

FIG. 6 is a schematic flowchart of another backlight brightness adjustment circuit control method according to embodiments of the present application;

FIG. 7 is a schematic flowchart of yet another backlight brightness adjustment circuit control method according to embodiments of the present application;

FIG. 8 is a schematic block diagram of an electronic device according to embodiments of the present application.

### DETAILED DESCRIPTION OF EMBODIMENTS

The technical solutions in the embodiments of the present application will be clearly and completely described below with reference to the accompanying figures in the embodiments of the present application. Obviously, the described embodiments are only some of the embodiments of the present application, not all of the embodiments. Based on the embodiments in this application, all other embodiments obtained by those of ordinary skill in the art without creative efforts fall within the scope of protection of this application.

It should be noted that the terms “first”, “second”, etc. in the description and claims of this application and the above-mentioned figures are used to distinguish similar objects and are not necessarily used to describe a specific order or sequence. It is to be understood that the data so used are interchangeable under appropriate circumstances so that the embodiments of the application described herein can be practiced in sequences other than those illustrated or described herein. Furthermore, the terms “include” and “having” and any variations thereof are intended to cover non-exclusive inclusions, for example, processes, methods, systems, products or servers that encompass a series of steps or elements need not be limited to those steps or elements that are explicitly listed. Those steps or elements may instead include other steps or elements that are not expressly listed or inherent to the processes, methods, products or apparatus.

This application is suitable for adjusting the backlight brightness of a Liquid Crystal Display (LCD) with a black frame insertion function, that is, when a LCD screen with a black frame insertion function preforms a backlight brightness adjustment, by sliding the slider on the system brightness adjustment control to a numerical interval, the LCD screen adjusts the backlight brightness to the backlight brightness level corresponding to the numerical interval according to the pre-established mapping relationship between the backlight brightness levels and the numerical intervals. However, in this backlight brightness adjustment method, the mapping relationship between the backlight brightness levels and the numerical intervals is the same for different users' devices. However, each user has different needs for adjusting the backlight brightness, which will cause users to be dissatisfied with the adjusted backlight brightness, resulting in a poor user experience. Therefore, this application provides a circuit that can adjust the backlight brightness in a targeted manner according to the user's adjustment needs, so as to meet the user's needs for personalized adjustment of the backlight brightness and realize stepless adjustment of the backlight brightness, thereby raising user satisfaction with adjusting backlight brightness and improving user experience.

A backlight brightness adjustment circuit provided by embodiments of the present application will be described in detail below with reference to the accompanying figures.

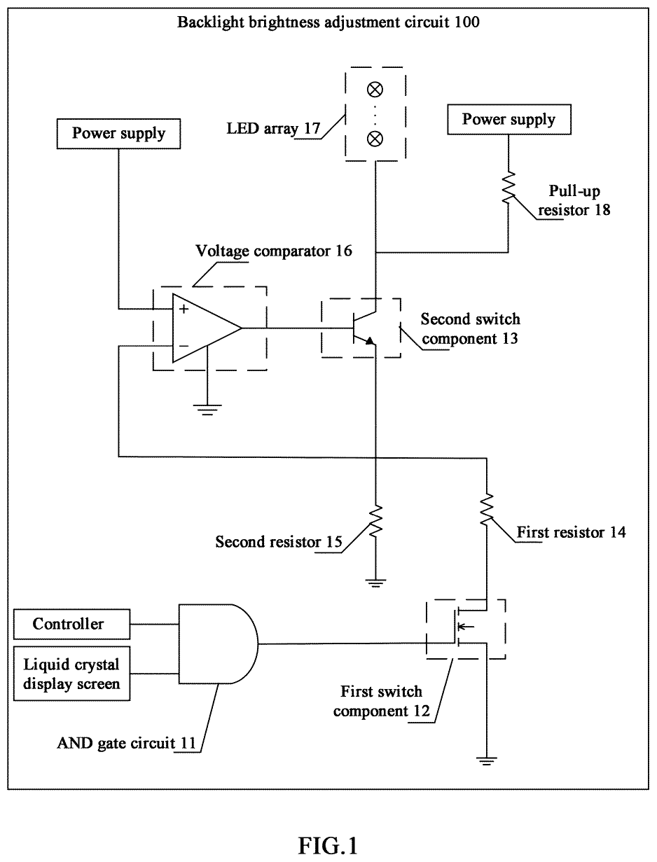

FIG. 1 is a schematic block diagram of a backlight brightness adjustment circuit according to embodiments of the present application.

As shown in FIG. 1, the backlight brightness adjustment circuit 100 of the present application may include: an AND gate circuit 11, a first switch component 12, a second switch component 13, a first resistor 14, a second resistor 15, a voltage comparator 16, an LED array 17 and a pull-up resistor 18;

A control end of the first switch component 12 is connected to a output of the AND gate circuit 11, one end of the first switch component 12 is connected to one end of the first resistor 14 and the other end of the first switch component 12 is connected to ground;

The other end of the first resistor 14 is connected to a first input of the voltage comparator 16, one end of the second switch component 13 and one end of the second resistor 15, and the other end of the second resistor 15 is connected to the ground;

A second input of the voltage comparator 16 is connected to a power supply, and an output of the voltage comparator 16 is connected to a control end of the second switch component 13;

The other end of the second switch component 13 is connected to the LED array 17 and one end of the pull-up resistor 18, and the other end of the pull-up resistor 18 is connected to the power supply;

A first input of the AND gate circuit 11 is connected to the controller, and A second input of the AND gate circuit 11 is connected to the liquid crystal display screen for controlling a working state of the first switch component 12 according to a first pulse width modulation signal output by the controller and a second pulse width modulation signal output by the liquid crystal display screen;

Wherein, the first pulse width modulation signal is generated based on a current brightness value of a backlight of the liquid crystal display screen, and a frequency of the first pulse width modulation signal is greater than a frequency of the second pulse width modulation signal.

In this embodiment of the present application, the pulse width modulation signal is specifically a PWM (Pulse Width Modulation) signal.

Among them, the frequency of the first pulse width modulation signal is usually hundreds or even thousands of times higher than the frequency of the second pulse width modulation signal, and is used to control the backlight brightness of the liquid crystal display (Liquid Crystal Display, LCD for short).

The frequency of the second pulse width modulation signal is consistent with the image refresh frequency. For example, if the refresh frequency of the image is: 72 Hz, 90 Hz, 120 Hz or others, a corresponding frequency of the second pulse width modulation signal is: 72 Hz, 90 Hz, 120 Hz or others.

Moreover, the second pulse width modulation signal is used to control the backlight of the LCD screen to turn on and off, so as to realize the black frame insertion function of the LCD screen.

During specific implementation, when the controller obtains the backlight brightness adjustment operation triggered by the user on the LCD screen, the controller will generate the first pulse width modulation signal corresponding to the current brightness value according to the current brightness value corresponding to the backlight brightness adjustment operation. In addition, the LCD screen automatically generates a second pulse width modulation signal with a frequency lower than the first pulse width modulation signal according to the image refresh frequency. Then, the controller sends the generated first pulse width modulation signal to the AND gate circuit 11, and at the same time, the LCD screen also sends the generated second pulse width modulation signal to the AND gate circuit 11, so that the AND gate circuit 11 determines the output result according to the first pulse width modulation signal and the second pulse width modulation signal. The output result is a high level or a low level.

After the AND gate circuit 11 receives the first pulse width modulation signal and the second pulse width modulation signal, it can determine whether the first pulse width modulation signal and the second pulse width modulation signal are both high level. If the first pulse width modulation signal and the second pulse width modulation signal are both high level, the output result of the AND gate circuit 11 is high level, otherwise the output result of the AND gate circuit 11 is low level. When the output result of the AND gate circuit 11 is high level, the first switch component 12 connected to the AND gate circuit 11 is turned on to connect the first resistor 14 to the backlight brightness adjustment circuit 100 and control the length of time that the first resistor 14 is connected to the backlight brightness adjustment circuit 100 according to the time of high level. That is, the conduction time of the first switch component 12 is controlled.

When the first resistor 14 is connected to the backlight brightness adjustment circuit 100, it can form a parallel structure with the second resistor 15, so that the total current limiting resistance in the backlight brightness adjustment circuit 100 becomes smaller. Among them, the length of time that the first resistor 14 is connected to the backlight brightness adjustment circuit 100 is determined according to the time of high-level. That is, the longer the high level time is and the longer the first resistor 14 is connected, the greater the current flowing to the total current limiting resistor, and then the supply current flowing to each LED lamp in the LED array 17 through the second switch component 13 also becomes larger. As a result, the brightness of each LED lamp in the LED array 17 becomes correspondingly brighter. In the same way, the shorter the time of high level is, the shorter the time the first resistor 14 is connected, and the smaller the current flowing to the total current limiting resistor, and thus the supply current flowing to each LED lamp in the LED array 17 through the second switch component 13 is also smaller. As a result, the brightness of each LED lamp in the LED array 17 becomes correspondingly darker.

That is to say, the embodiment of the present application adjusts the current limiting resistor in the backlight brightness adjustment circuit 100 by controlling whether the first resistor 14 is connected to the backlight brightness adjustment circuit 100 and controlling the access time of the first resistor 14 in order to adjust the current of the backlight of the screen based on the adjusted current limiting resistor. In this way, the backlight brightness can be adjusted steplessly by adjusting the current, thereby improving the user's satisfaction with the backlight brightness adjustment and improving the user experience.

In this embodiment, a duty cycle of the first pulse width modulation signal generated by the controller changes with the current brightness value corresponding to the backlight brightness adjustment operation sent by the user. For example, if the current brightness value is 120 nits, the duty cycle of the first pulse width modulation signal generated by the controller based on the current brightness value of 120 nits may be 47.27%, etc.

That is to say, the controller of the present application can generate the first pulse width modulation signal with different duty cycles according to the current brightness value corresponding to the backlight brightness adjustment operation, and then the backlight brightness adjustment circuit can adjust backlight brightness according to first pulse width modulation signals with different duty cycles. That is, the higher the duty cycle, the smaller the current limiting resistor, the greater the current of the corresponding screen backlight, and the brighter the backlight brightness.

Wherein, the controller generates the first pulse width modulation signal according to the current brightness value corresponding to the backlight brightness adjustment operation, which may be an inquiry of the mapping relationship between the first pulse width signal and the brightness value according to the current brightness value, or may also be a direct generation of a first pulse width signal based on the current brightness value, etc., which are not limited here. The specific implementation process will be described in detail in the following embodiments, and will not be described in detail here.

In this embodiment of the present application, the first switch component 12 is a metal oxide semiconductor field effect transistor.

In addition, the second switch component 13 is a triode.

Considering that the LCD screen is provided with backlight by multiple LED lamps, the LED array 17 in this embodiment includes at least one LED lamp.

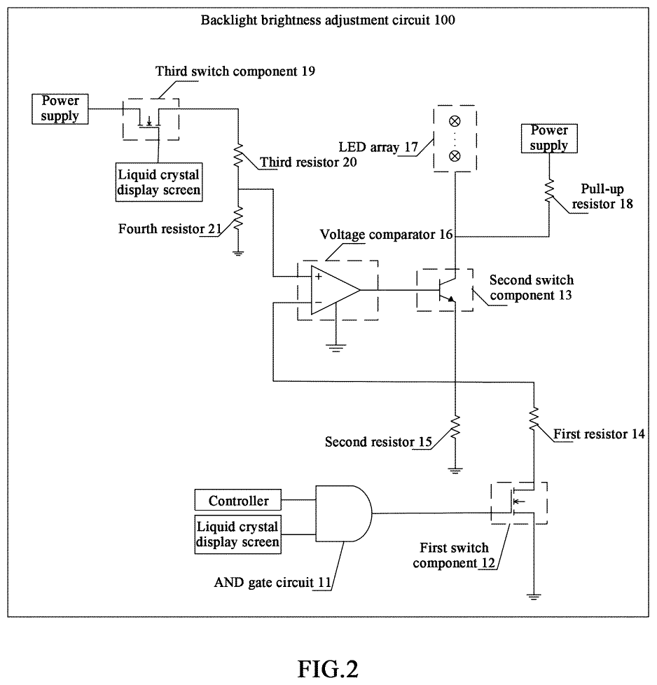

Furthermore, in order to ensure that when the output result of the AND gate circuit 11 is low level, the LCD screen can also have a black frame insertion function to reduce the smear produced by the LCD screen which causes the user to feel dizzy. The backlight brightness adjustment circuit 100 provided by the embodiment of the present application further includes: a third switch component 19, a third resistor 20 and a fourth resistor 21, as shown in FIG. 2.

One end of the third switch component 19 is connected to one end of the third resistor 20, the other end of the third switch component 19 is connected to the power supply, and a control end of the third switch component 19 is connected to the output of the above-mentioned LCD screen;

The other end of the third resistor 20 is connected to the second input of the voltage comparator 16 and one end of the fourth resistor 21;

The other end of the fourth resistor 21 is connected to the ground.

In the embodiment of the present application, the third switch component 19 is a metal oxide semiconductor field effect transistor.

Specifically, when no user-triggered backlight brightness adjustment operation is received, the LCD screen automatically generates a second pulse width modulation signal according to the image refresh frequency, and sends the second pulse width modulation signal to the third switch component 19. When the second pulse width modulation signal is at a high level, the third switch component 19 is turned on in order to connect the power supply to the backlight brightness adjustment circuit 100. In addition, the power supply voltage is divided by the third resistor 20 and the fourth resistor 21 to use the divided voltage as the second input (non-inverting input) of the voltage comparator 16 so that the voltage comparator 16 performs voltage comparison between the first input (inverting input) and the second input (non-inverting input) to determine whether the output outputs a high level or a low level. When the voltage comparator 16 outputs a high level, it means that the LCD screen is currently in an image display state, and each LED lamp in the LED array 17 is controlled to be in a lighting state; when the voltage comparator 16 outputs a low level, it means that the LCD screen is currently in an image refresh state, each LED light in the LED array 17 can be controlled to be in an off state, and the liquid crystal can be controlled to deflect. It turns off the backlight when the liquid crystal deflects, thereby eliminating smear on the LCD screen.

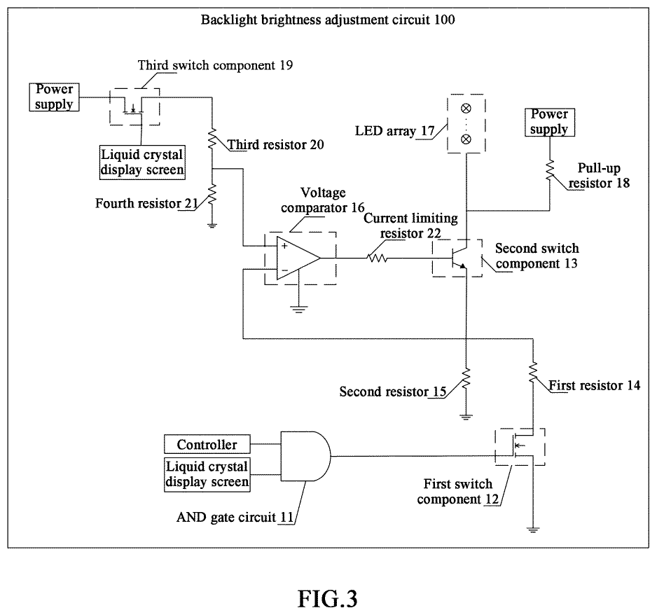

As shown in FIG. 3, the backlight brightness adjustment circuit 100 according to embodiments of the present application further includes: a current limiting resistor 22 connected in series between the voltage comparator 16 and the second switch component 13.

During specific implementation, one end of the current limiting resistor 22 is connected to the output of the voltage comparator 16, and the other end of the current limiting resistor 22 is connected to the control end of the second switch component 13.

In the embodiment of the present application, a current limiting resistor 22 is connected in series between the voltage comparator 16 and the second switch component 13 in the backlight brightness adjustment circuit 100, thereby preventing the output voltage of the voltage comparator 16 from being too large, which may cause the second switch component 13 to fail to work normally or even burn out, thereby reducing unnecessary safety risks.

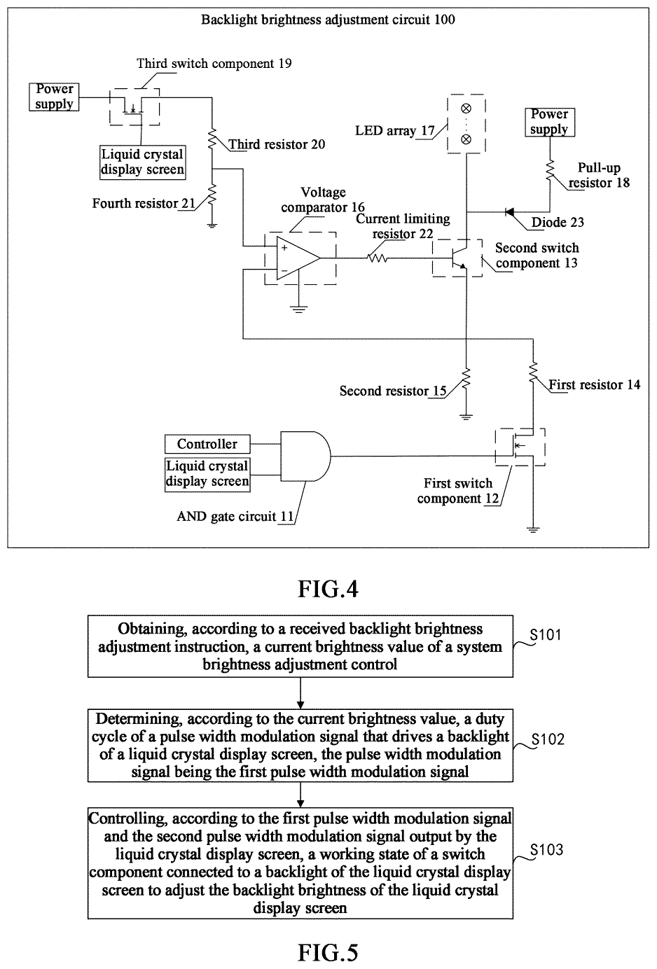

In addition, the backlight brightness adjustment circuit 100 provided by the embodiment of the present application further includes: a diode 23, as shown in FIG. 4.

Wherein, the anode of the diode 23 is connected to the other end of the pull-up resistor 18;

The cathode of the diode 23 is connected to the LED array 17 and the other end of the second switch component 12.

Specifically, by adding a diode 23 between the pull-up resistor 18, the LED array 17 and the second switch component 12, the diode 23 will be used to detect whether the LED array 17 is operating normally.

The backlight brightness adjustment circuit is provided by this application. An AND gate circuit, a first switch component, a second switch component, a first resistor, a second resistor, a voltage comparator and a pull-up resistor are arranged in the backlight brightness adjustment circuit of the screen. It controls whether the first resistor is connected to the backlight brightness adjustment circuit based on the pulse width modulation signal output by the controller and the LCD screen, so as to adjust the current size of the screen backlight by adjusting the size of the current-limiting resistor in the backlight brightness adjustment circuit, thus achieving stepless adjustment of backlight brightness, thereby improving user satisfaction with backlight brightness adjustment and improving user experience.

FIG. 5 is a schematic flowchart of a backlight brightness adjustment circuit control method according to embodiments of the present application. The backlight brightness adjustment circuit control method provided by the embodiments of the present application can be applied to the backlight brightness adjustment circuit of the above embodiments. As shown in FIG. 5, the backlight brightness adjustment circuit control method includes the following steps:

S101: Obtaining, according to a received backlight brightness adjustment instruction, a current brightness value of a system brightness adjustment control.

In a process using electronic devices, when the brightness of the screen backlight is too dark or too bright, it will affect the user's ability to view the content displayed on the screen. Therefore, when the screen backlight brightness is not suitable for the user to view the screen display content, the user can send a backlight brightness adjustment instruction to the electronic device, so that the electronic device performs the backlight brightness adjustment operation according to the backlight brightness adjustment instruction sent by the user.

As an optional implementation method, the backlight brightness adjustment instructions can be received in the following ways:

### Method One

Receive backlight brightness adjustment instructions triggered by the user through the handle.

When the electronic device is a VR device, the screen of the VR device is only used to display images and cannot support the user's touch operations. Therefore, in order to meet the user's input needs, the VR device uses an external device such as a VR handle to enable the user to perform input operations through the VR handle. Among them, the VR handle can be a wireless handle or a wired handle. When the VR handle is a wireless handle, the handle can be a Bluetooth handle, etc., and there are no specific restrictions on it here.

That is to say, when the user needs to adjust the backlight brightness of the screen, he can send a backlight brightness adjustment instruction by controlling the handle of the electronic device based on the content displayed on the screen. For example, by triggering the setting button on the handle for adjusting the backlight brightness, a backlight brightness adjustment instruction can be sent.

It should be noted that when the electronic device is other devices and the setting is compatible with an LCD screen that supports user touch and a handle, the user can trigger the background brightness adjustment instruction through the handle or touch the LCD screen to trigger the background brightness adjustment instruction. There are no restrictions on it.

### Method 2

If it is determined that the user performs a backlight brightness adjustment action based on the obtained user gesture, the background brightness adjustment instruction is triggered.

When the electronic device is a VR device, the screen of the VR device is only used to display images and cannot support the user's touch operations. Therefore, in order to meet the user's input needs, the VR device can also collect the user's gestures through a camera and identify gestures collected by the camera to determine whether the user's gesture is a backlight brightness adjustment action. When it is determined that the user gesture is a backlight brightness adjustment action, the background brightness adjustment instruction is automatically triggered.

Among them, when recognizing the gestures collected by the camera, the gesture image is input into the gesture detection model to detect the gesture area through the gesture detection model. Then the gesture area is input into the gesture recognition model to determine whether the user's gesture is a backlight brightness adjustment action. It should be noted that the process of processing gesture images using gesture detection models and gesture recognition models is a conventional technical means, which will not be described in detail here.

In order to improve the accuracy of gesture recognition, this embodiment may preprocess the collected gesture images before recognizing the collected gestures. Then, recognition operations on the preprocessed gesture images is performed. The preprocess of gesture image can include: format conversion, image enhancement, image size adjustment, etc.

After receiving the backlight brightness adjustment instruction sent by the user, the electronic device can obtain the current brightness value of the system brightness adjustment control according to the backlight brightness adjustment instruction. Among them, the system brightness adjustment control refers to a control that adjusts the brightness of the backlight of the LCD. This control can support a variety of operations, such as sliding or clicking operation. In this embodiment, the system brightness adjustment control may be a brightness slide bar.

Specifically, obtaining the current brightness value of the system brightness adjustment control can be achieved by following way: determining the current position of the slider on the system brightness adjustment control; obtaining the current brightness value of the system brightness adjustment control according to the current position of the slider; where, the system brightness adjustment control is divided into multiple positions, and each position corresponds to a brightness value.

For example, when the brightness value range of the system brightness adjustment control is [0, 255], then the system brightness adjustment control is divided into 256 positions according to the number of brightness values in the brightness range. Alternatively, the system brightness adjustment control is divided into thousands, tens of thousands or even more positions, which can be adaptively configured based on accuracy of the brightness adjustment. There are no specific restrictions on it here. Then, based on the corresponding relationship between each brightness value and the position, a mapping relationship between the positions and the brightness values is established.

Take the system brightness adjustment control which is divided into 256 positions as an example to illustrate, as shown in Table 1 below:

TABLE 1

| | Brightness value of the system brightness | |
|---|---|---|
| Position | adjustment control | |
| 1st position | 0 | nits |
| 2nd position | 1 | nits |
| . . . | . . . | |
| 256^{th} position | 255 | nits |

Furthermore, when obtaining the current brightness value of the system brightness adjustment control, the mapping relationship between the above positions and the brightness values can be queried according to the position of the slider of the system brightness adjustment control to determine the current brightness value of the system brightness adjustment control.

For example, if the current position of the slider on the system brightness adjustment control is the 57th position, it can be determined that the current brightness value of the system brightness adjustment control is 56 nits by querying the mapping relationship between the corresponding positions and the brightness values in Table 1 above.

S102: Determining, according to the current brightness value, a duty cycle of a pulse width modulation signal that drives a backlight of a liquid crystal display screen, the pulse width modulation signal being the first pulse width modulation signal.

The duty cycle of the pulse width modulation signal refers to the ratio of high-level time and low-level time within one switching operation of the screen backlight. Among them, the longer the high level time is during one switching operation on the screen backlight, the larger the duty cycle of the pulse width modulation signal will be, and conversely, the smaller the duty cycle of the pulse width modulation signal will be. The duty cycle of the pulse width modulation signal can be expressed in percent. For example, if the screen backlight is all high level during a switch operation, then the duty cycle of the pulse width modulation signal is 100%.

For example, after obtaining the current brightness value of the system brightness adjustment control, the embodiment of the present application can determine the duty cycle of the pulse width modulation signal that drives the backlight of the liquid crystal display screen based on the current brightness value. Specifically, this can be achieved in the following ways:

### The First Implementation

By using the current brightness value, the mapping relationship between the brightness values of the preset system brightness adjustment control and the duty cycles of the pulse width modulation signal is queried to determine the duty cycle of the pulse width modulation signal corresponding to the current brightness value. The duty cycle of the queried pulse width modulation signal is determined as the duty cycle of the pulse width modulation signal that drives the backlight of the liquid crystal display screen.

For example, if the current brightness value is 120 nits, by querying the mapping relationship between the brightness values of the preset system brightness adjustment control and the duty cycles of the pulse width modulation signal based on 120 nits, it is determined that the duty cycle of the pulse width modulation signal corresponding to the current brightness value of 120 nits is 47.27%. Then, it is determined that the duty cycle of the pulse width modulation signal that drives the backlight of the liquid crystal display screen is 47.27%.

### The Second Implementation

By using the current brightness value, the duty cycle of the pulse width modulated signal that drives the backlight of the liquid crystal display screen is calculated.

Specifically, when calculating the duty cycle of the pulse width modulation signal, the calculation can be based on the current brightness value in a preset manner. The preset method may be any algorithm or rule that can calculate the duty cycle of the pulse width modulation signal based on the brightness value, etc., which is not specifically limited here.

For example, when the current brightness value is 150 nits, the electronic device can calculate the duty cycle of the pulse width modulation signal corresponding to 150 nits according to 150 nits in a preset manner: 58.59%. Then, it is determined that the duty cycle of the pulse width modulation signal that drives the backlight of the LCD is 58.59%.

It should be noted that the above two implementation modes are only used as exemplary descriptions of the embodiments of the present application and are not intended to specifically limit the present application.

Furthermore, the pulse width modulation signal determined by the above two methods is used as the first pulse width modulation signal.

S103. controlling, according to the first pulse width modulation signal and the second pulse width modulation signal output by the liquid crystal display screen, a working state of a switch component connected to the backlight of the liquid crystal display screen to adjust the backlight brightness of the liquid crystal display screen.

Wherein, the frequency of the first pulse width modulation signal is greater than the frequency of the second pulse width modulation signal.

In the embodiment of the present application, the second pulse width modulation signal is generated according to the image refresh frequency. For example, if the refresh frequency of the image is: 72 Hz, 90 Hz, 120 Hz or others, the corresponding frequency of the second pulse width modulation signal is: 72 Hz, 90 Hz, 120 Hz or others.

Moreover, the second pulse width modulation signal is used to control the backlight of the LCD screen to turn on and off, so as to realize the black frame insertion function of the LCD screen.

In specific implementation, it is determined whether the first pulse width modulation signal and the second pulse width modulation signal are both high level. When it is determined that the first pulse width modulation signal and the second pulse width modulation signal are high level, the switch component is controlled to be turned on; otherwise, the switch component is controlled to be turned off. See FIG. 1 for details.

It can be understood that this application controls the switching component to be turned on according to the first pulse width modulation signal and the second pulse width modulation signal, to connect the first resistor into the backlight brightness adjustment circuit, in order to adjust the current limiting resistor in the backlight brightness adjustment circuit, so as to adjust the size of the current of the screen backlight, thereby achieving stepless adjustment of the backlight brightness.

The backlight brightness adjustment circuit control method provided by this application obtains the current brightness value corresponding to the backlight brightness adjustment instruction to determine the duty cycle of the pulse width modulation signal that drives the backlight of the liquid crystal display screen based on the current brightness value. The pulse width modulation signal is used as the first pulse width modulation signal, and the working state of the switch component connected to the backlight of the liquid crystal display screen is controlled according to the first pulse width modulation signal and the second pulse width modulation signal output by the liquid crystal display screen, so as to adjust the backlight brightness of the liquid crystal display screen. As a result, the backlight brightness can be steplessly adjusted, thereby improving the user's satisfaction with the backlight brightness adjustment and improving the user experience.

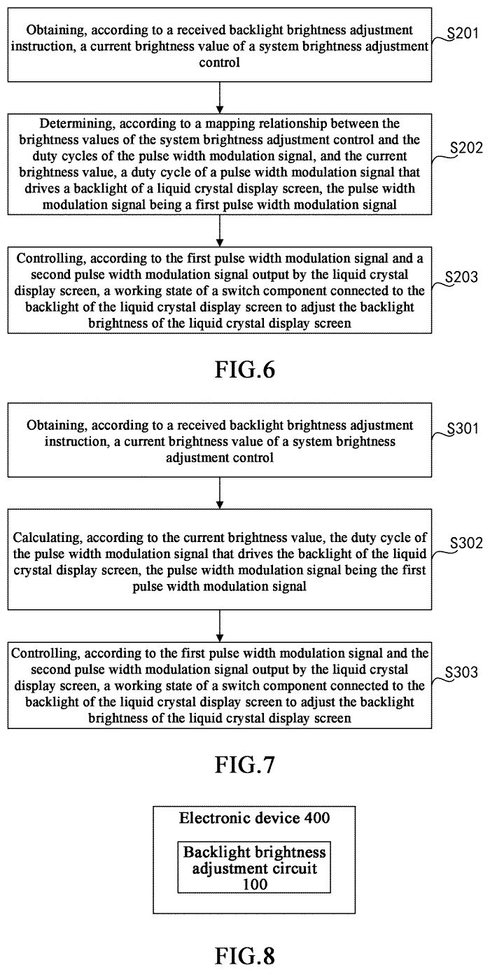

As an optional implementation of this application, when determining the duty cycle of the pulse width modulation signal that drives the backlight of the liquid crystal display screen based on the current brightness value, the duty cycle of the pulse width modulation signal that drives the backlight of the liquid crystal display screen can be determined by querying the mapping relationship between the brightness values of the preset system brightness adjustment control and the duty cycles of the pulse width modulation signal according to the current brightness value. Then, with reference to FIG. 6, the above-mentioned process of determining the duty cycle of the pulse width modulation signal for driving the backlight of the liquid crystal display screen will be described in detail.

As shown in FIG. 6, the backlight brightness adjustment circuit control method includes the following steps:

S201: Obtaining, according to a received backlight brightness adjustment instruction, a current brightness value of a system brightness adjustment control.

S202. Determining, according to a mapping relationship between brightness values of the system brightness adjustment control and duty cycles of the pulse width modulation signal, and the current brightness value, a duty cycle of a pulse width modulation signal that drives a backlight of a liquid crystal display screen, the pulse width modulation signal being the first pulse width modulation signal.

In the embodiment of the present application, the mapping relationship between the brightness values of the system brightness adjustment control and the duty cycles of the pulse width modulation signal may be: calculating, based on each brightness value in the brightness value range of the system brightness adjustment control, the duty cycle of the pulse width modulation signal corresponding to each brightness value. Then, according to the duty cycle of the pulse width modulation signal corresponding to each brightness value, a mapping relationship between the brightness values and the duty cycles of the pulse width modulation signal is established.

Among them, based on each brightness value in the brightness value range of the system brightness adjustment control, calculating the duty cycle of the pulse width modulation signal corresponding to each brightness value, specifically comprises: calculating a distance between each brightness value and a minimum brightness value of the system brightness adjustment control, and a distance between the minimum and maximum brightness values of the system brightness adjustment control, then calculating the ratio of the distance between each brightness value and the minimum brightness value of the system brightness adjustment control, and the distance between the minimum and the maximum brightness value of the system brightness adjustment control, and determining the ratio as the duty cycle of the pulse width modulation signal corresponding to each brightness value. Of course, in addition to the above method for calculating the duty cycle of the pulse width modulation signal corresponding to each brightness value, this application can also be implemented through other methods, which are not specifically limited here.

Moreover, after establishing the mapping relationship between the brightness values of the system brightness adjustment control and the duty cycles of the pulse width modulation signal, the mapping relationship can be stored, so that the duty cycle of the pulse-width modulated signal that drives the backlight of the liquid crystal display screen may be determined based on the stored mapping relationship is established.

Further, after obtaining the current brightness value of the system brightness adjustment control according to the backlight brightness adjustment instruction sent by the user, based on the current brightness value, the duty cycle of the pulse width modulation signal corresponding to the current brightness value can be found in the stored mapping relationship between the brightness values of the system brightness adjustment control and the duty cycles of the pulse width modulation signal. Then, the found pulse width modulation signal is used as the first pulse width modulation signal.

S203. Controlling, according to the first pulse width modulation signal and the second pulse width modulation signal output by the liquid crystal display screen, a working state of a switch component connected to the backlight of the liquid crystal display screen to adjust the backlight brightness of the liquid crystal display screen.

Wherein, the frequency of the first pulse width modulation signal is greater than the frequency of the second pulse width modulation signal.

The backlight brightness adjustment circuit control method provided by this application obtains the current brightness value corresponding to the backlight brightness adjustment instruction and determines the duty cycle of the pulse width modulation signal that drives the backlight of the liquid crystal display screen based on the current brightness value. The pulse width modulation signal is used as a first pulse width modulation signal. According to the first pulse width modulation signal and the second pulse width modulation signal output by the liquid crystal display screen, the working state of the switch component connected to the backlight of the liquid crystal display screen is controlled to adjust the backlight brightness of the liquid crystal display screen. As a result, the backlight brightness can be steplessly adjusted, thereby improving the user's satisfaction with the backlight brightness adjustment and improving the user experience. In addition, by pre-storing the mapping relationship between the brightness values of the system brightness adjustment control and the duty cycles of the pulse width modulation signal, the duty cycle of the pulse width modulation signal that drives the LCD backlight is determined by directly querying the mapping relationship based on the obtained current brightness value, thereby effectively increasing the adjustment speed of the screen backlight brightness.

As another optional implementation of the present application, when considering that the duty cycle of the pulse width modulation signal that drives the backlight of the liquid crystal display screen is determined based on the current brightness value, the duty cycle of the pulse width modulation signal that drives the backlight of the liquid crystal display screen can also be calculated based on the current brightness value. Then, the above-mentioned process of calculating the duty cycle of the pulse width modulation signal that drives the backlight of the liquid crystal display screen will be further explained below with reference to FIG. 7.

As shown in FIG. 7, the method of backlight brightness adjustment includes the following steps:

S301: Obtaining, according to a received backlight brightness adjustment instruction, the current brightness value of a system brightness adjustment control.

S302: Calculating, according to the current brightness value, the duty cycle of the pulse width modulation signal driving the backlight of the liquid crystal display screen, the pulse width modulation signal being the first pulse width modulation signal.

Exemplarily, based on the current brightness value, calculating the duty cycle of the pulse width modulation signal that drives the backlight of the liquid crystal display screen can be implemented in the following manner: first, determining the first distance between the current brightness value and a minimum brightness value of the system brightness adjustment control, and determining a second distance between the minimum brightness value and the maximum brightness value of the system brightness adjustment control, and then obtaining the ratio by dividing the first distance by the second distance, and using the ratio as the duty cycle of the pulse width modulated signal that drives the backlight of the liquid crystal display screen.

In specific implementation, it can be achieved through the following formula:

$${Z}_{i} = \frac{{a}_{i} + 1}{{a}_{n} + 1} * 100 \%$$

Among them, Zᵢ represents the duty cycle of the i-th pulse width modulation signal corresponding to the i-th brightness value, aᵢ represents the i-th brightness value, and aₙ represents the n-th brightness value, i≤n, 0≤n≤255.

For example, if the current brightness value is 250 nits, the duty cycle of the pulse width modulation signal that drives the backlight of the liquid crystal display screen may be calculated by using the formula above as:

$${Z}_{250} = \frac{250 + 1}{255 + 1} * 100 \% = 98.05 \% .$$

Furthermore, the pulse width modulation signal determined in the above manner is used as the first pulse width modulation signal.

S303. Controlling, according to the first pulse width modulation signal and the second pulse width modulation signal output by the liquid crystal display screen, a working state of a switch component connected to the backlight of the liquid crystal display screen to adjust the backlight brightness of the liquid crystal display screen.

Wherein, the frequency of the first pulse width modulation signal and the frequency of the second pulse width modulation signal are different.

The backlight brightness adjustment circuit control method provided by the embodiment of the present application obtains the current brightness value corresponding to the backlight brightness adjustment instruction, and determines the duty cycle of the pulse width modulation signal that drives the backlight of the liquid crystal display screen based on the current brightness value. The pulse width modulation signal is used as a first pulse width modulation signal, and according to the first pulse width modulation signal and the second pulse width modulation signal output by the liquid crystal display screen, the working state of the switch component connected to the backlight of the liquid crystal display screen is controlled to adjust the backlight brightness of the liquid crystal display screen. As a result, the backlight brightness can be steplessly adjusted, thereby improving the user's satisfaction with the backlight brightness adjustment and improving the user experience.

FIG. 8 is a schematic block diagram of an electronic device according to embodiments of the present application.

As shown in FIG. 8, the electronic device 400 includes the backlight brightness adjustment circuit 100 of any of the aforementioned embodiments.

In this embodiment, the electronic device is preferably a virtual reality device, that is, a VR (Virtual Reality) device, such as a VR all-in-one machine, a VR helmet, or VR glasses.

It should be understood that this electronic device embodiment and the foregoing backlight brightness adjustment circuit embodiment may correspond to each other, and similar descriptions may refer to embodiments of the backlight brightness adjustment circuit. To avoid repetition, they will not be repeated here.

The electronic device provided by the embodiment of the present application includes a backlight brightness adjustment circuit. The backlight brightness adjustment is provided with an AND gate circuit, a first switch component, a second switch component, a first resistor, a second resistor, a voltage comparator and a pull-up resistor, and controls whether the first resistor is connected to the backlight brightness adjustment circuit according to the pulse width modulation signal output by the controller and the liquid crystal display screen, so as to adjust the size of the current of the screen backlight by adjusting the size of the current-limiting resistor in the backlight brightness adjustment circuit, thereby achieving stepless adjustment of backlight brightness, improving user satisfaction with backlight brightness adjustment and improving user experience.

Those skilled in the art can appreciate that the modules and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of this application.

In the several embodiments provided in this application, it should be understood that the disclosed systems, apparatus and methods can be implemented in other ways. For example, the apparatus embodiments described above are only illustrative. For example, the division of the modules is only a logical function division. In actual implementation, there may be other division methods. For example, multiple modules or components may be combined or may be Integrated into another system, or some features can be ignored, or not implemented. On the other hand, the coupling or direct coupling or communication connection between each other shown or discussed may be through some interfaces, indirect coupling or communication connection of apparatus or modules, and may be in electrical, mechanical or other forms.

Modules described as separate components may or may not be physically separated, and components shown as modules may or may not be physical modules, that is, they may be located in one place, or they may be distributed to multiple network units. Some or all of the modules can be selected according to actual needs to achieve the purpose of the solution of this embodiment. For example, each functional module in each embodiment of the present application can be integrated into a processing module, or each module can exist physically alone, or two or more modules can be integrated into one module.

The above are only specific implementations of the present application, but the protection scope of the present application is not limited thereto. Any person familiar with the technical field can easily think of changes or substitutions within the technical scope disclosed in the present application, which should be covered by the protection scope of this application. Therefore, the protection scope of this application shall be subject to the protection scope of the claims.

1. A backlight brightness adjustment circuit, comprising: an AND gate circuit, a first switch component, a second switch component, a first resistor, a second resistor, a voltage comparator, an LED array, and a pull-up resistor;
a control end of the first switch component being connected to an output of the AND gate circuit, one end of the first switch component being connected to one end of the first resistor, and the other end of the first switch component being connected to ground;
the other end of the first resistor being connected to a first input of the voltage comparator, one end of the second switch component, and one end of the second resistor, and the other end of the second resistor being connected to the ground;
a second input of the voltage comparator being connected to a power supply, and an output of the voltage comparator being connected to a control end of the second switch component;
the other end of the second switch component being connected to the LED array and one end of the pull-up resistor, and the other end of the pull-up resistor being connected to the power supply;
a first input of the AND gate circuit being connected to a controller, and a second input of the AND gate circuit being connected to a liquid crystal display screen for controlling a working state of the first switch component according to a first pulse width modulation signal output by the controller and a second pulse width modulation signal output by the liquid crystal display screen; and
wherein the first pulse width modulation signal is generated based on a current brightness value of a backlight of the liquid crystal display screen, and a frequency of the first pulse width modulation signal is greater than a frequency of the second pulse width modulation signal.

2. The backlight brightness adjustment circuit of claim 1, further comprising: a third switch component, a third resistor, and a fourth resistor;
one end of the third switch component being connected to one end of the third resistor, the other end of the third switch component being connected to the power supply, and a control end of the third switch component being connected to the liquid crystal display screen;
the other end of the third resistor being connected to the second input of the voltage comparator and one end of the fourth resistor; and
the other end of the fourth resistor being connected to the ground.

3. The backlight brightness adjustment circuit of claim 1, further comprising: a current limiting resistor being connected in series between the voltage comparator and the second switch component.

4. The backlight brightness adjustment circuit of claim 1, further comprising: a diode;
an anode of the diode being connected to the other end of the pull-up resistor; and
a cathode of the diode being connected to the LED array and the other end of the second switch component.

5. The backlight brightness adjustment circuit of claim 1, wherein the first switch component is a metal oxide semiconductor field effect transistor.

6. The backlight brightness adjustment circuit of claim 1, wherein the second switch component is a triode.

7. The backlight brightness adjustment circuit of claim 1, wherein the LED array includes at least one LED lamp.

8. A method for controlling a backlight brightness adjustment circuit, comprising:
obtaining, according to a received backlight brightness adjustment instruction, a current brightness value of a system brightness adjustment control;
determining, according to the current brightness value, a duty cycle of a pulse width modulation signal that drives a backlight of a liquid crystal display screen, the pulse width modulation signal being a first pulse width modulation signal;
controlling, according to the first pulse width modulation signal and a second pulse width modulation signal output by the liquid crystal display screen, a working state of a switch component connected to the backlight of the liquid crystal display screen to adjust the backlight brightness of the liquid crystal display screen;
wherein a frequency of the first pulse width modulation signal is greater than a frequency of the second pulse width modulation signal.

9. The method of claim 8, wherein controlling a working state of a switch component connected to the backlight of the liquid crystal display screen to adjust the backlight brightness of the liquid crystal display screen comprises:
in response to the first pulse width modulation signal and the second pulse width modulation signal being high level, controlling the switch component to be turned on; otherwise, controlling the switch component to be turned off.

10. The method of claim 8, wherein determining a duty cycle of a pulse width modulation signal that drives a backlight of a liquid crystal display screen comprises:
determining, according to a mapping relationship between brightness values of the system brightness adjustment control and duty cycles of the pulse width modulation signal, and the current brightness value, the duty cycle of the pulse width modulation signal that drives the backlight of the liquid crystal display screen;
or,
calculating, according to the current brightness value, the duty cycle of the pulse width modulation signal that drives the backlight of the liquid crystal display screen.

11. The method of claim 10, wherein calculating, according to the current brightness value, the duty cycle of the pulse width modulation signal that drives the backlight of the liquid crystal display screen comprises:
determining a first distance between the current brightness value and a minimum brightness value of the system brightness adjustment control, and a second distance between the minimum brightness value and a maximum brightness value of the system brightness adjustment control; and
calculating a ratio of the first distance and the second distance, and using the ratio as the duty cycle of the pulse width modulation signal that drives the backlight of the liquid crystal display screen.

12. The method of claim 8, wherein obtaining the current brightness value of the system brightness adjustment control comprises:
determining a current position of a slider on the system brightness adjustment control; and
obtaining, according to the current position of the slider, the current brightness value of the system brightness adjustment control;
wherein, the system brightness adjustment control is divided into multiple positions, and each position corresponds to a brightness value.

13. An electronic device, comprising: the backlight brightness adjustment circuit comprising: an AND gate circuit, a first switch component, a second switch component, a first resistor, a second resistor, a voltage comparator, an LED array, and a pull-up resistor;
a control end of the first switch component being connected to an output of the AND gate circuit, one end of the first switch component being connected to one end of the first resistor, and the other end of the first switch component being connected to ground;
the other end of the first resistor being connected to a first input of the voltage comparator, one end of the second switch component, and one end of the second resistor, and the other end of the second resistor being connected to the ground;
a second input of the voltage comparator being connected to a power supply, and an output of the voltage comparator being connected to a control end of the second switch component;
the other end of the second switch component being connected to the LED array and one end of the pull-up resistor, and the other end of the pull-up resistor being connected to the power supply;
a first input of the AND gate circuit being connected to a controller, and a second input of the AND gate circuit being connected to a liquid crystal display screen for controlling a working state of the first switch component according to a first pulse width modulation signal output by the controller and a second pulse width modulation signal output by the liquid crystal display screen; and
wherein the first pulse width modulation signal is generated based on a current brightness value of a backlight of the liquid crystal display screen, and a frequency of the first pulse width modulation signal is greater than a frequency of the second pulse width modulation signal.

14. The electronic device of claim 13, wherein the backlight brightness adjustment circuit further comprises: a third switch component, a third resistor, and a fourth resistor;
one end of the third switch component being connected to one end of the third resistor, the other end of the third switch component being connected to the power supply, and a control end of the third switch component being connected to the liquid crystal display screen;
the other end of the third resistor being connected to the second input of the voltage comparator and one end of the fourth resistor; and
the other end of the fourth resistor being connected to the ground.

15. The electronic device of claim 13, wherein the backlight brightness adjustment circuit further comprises: a current limiting resistor being connected in series between the voltage comparator and the second switch component.

16. The electronic device of claim 13, wherein the backlight brightness adjustment circuit further comprises: a diode;
an anode of the diode being connected to the other end of the pull-up resistor; and
a cathode of the diode being connected to the LED array and the other end of the second switch component.

17. The electronic device of claim 13, wherein the first switch component is a metal oxide semiconductor field effect transistor.

18. The electronic device of claim 13, wherein the second switch component is a triode.

19. The electronic device of claim 13, wherein the LED array includes at least one LED lamp.
